(19) United States
(12) Patent Application Publication
(10) Pub. No.: US 2020/0074460 A1
(43) Pub. Date: Mar. 5, 2020

(54) SYSTEM AND METHOD FOR A STABLE CRYPTOCURRENCY

(71) Applicant: ROCK STABLE TOKEN INC, Bellevue, WA (US)

(72) Inventor: Carlos C. TAPANG, Bellevue, WA (US)

(73) Assignee: ROCK STABLE TOKEN INC

(21) Appl. No.: 16/558,398

(22) Filed: Sep. 3, 2019

Related U.S. Application Data
(60) Provisional application No. 62/726,649, filed on Sep. 4, 2018.

(51) Int. Cl. G06Q 20/38; G06Q 20/36; G06Q 20/06; G06Q 20/20

(52) U.S. Cl. CPC G06Q 20/389; G06Q 20/3678; G06Q 2220/00; G06Q 20/381; G06Q 20/202; G06Q 20/0658

(57) ABSTRACT

A system and method for a stable cryptocurrency that uses multiple stabilization functions to obtain a network effect.

### FIELD OF THE INVENTION

The present invention, in at least some embodiments, is of a system and method for a stable cryptocurrency and in particular, of such a system and method that first gains trust in the accept-side to obtain a network effect.

### BACKGROUND OF THE INVENTION

Currently many cryptocurrencies, such as Bitcoin, have varied wildly in price. This is highly problematic from the point of the view of the coin holder: if a cryptocurrency coin can vary in price by multiple hundreds of percentage points in a matter of months, it is hard for the user to plan spending, and to be able to rely upon the coin retaining its monetary value until needed.

Hence the value proposition for stable cryptocurrencies: these are new currencies that are on the blockchain and yet stable, these are currencies you can use everyday to buy groceries, pay for lunch, etc, that can even be more stable than fiat. Imagine that: cryptocurrencies that freely compete with each other, without influence from any government. The most stable currency wins in the competition. These new central banks will not be monopolies in any one country; these currencies will be usable everywhere.

How is it possible to introduce and market such a currency? The coin can't be marketed as stable, because then nobody would be interested in buying it. Originally Ethereum had the right strategy: allow the ether value to increase at first, by limiting the quantity released, but then later allowing that quantity to increase according to demand, thereby making it stable. Unfortunately, the Ethereum community has chosen a different path. They now want to limit the quantity of ethers released, just like Bitcoin.

There are several requirements for money to be recognized and used as money. Notice that none of these requirements mention the government—but they are requirements for a stablecoin (a stable cryptocurrency).

1. It has to be “fungible”—which means that it is divisible into smaller parts, and one part that is equal to another in size can be exchanged for equivalent value of goods.

2. It has to be something that a large number of people value, and can get hold of in exchange for something else; ideally, people should already have it in their hands so they can spend it (exchange it);

3. It has to be stable in value over time. This requirement is not well understood, even by experts. Furthermore, without wishing to be limited by a single hypothesis, it appears that this requirement presupposes quantity that is adjustable.

Requirement 1 is already met by blockchain tokens. Requirements 2 and 3 are difficult to meet because the introduction of lots of crypto money (essentially hundreds of currency experiments) has shown that these two requirements are achieved by market forces that are opposing each other. That is, in order for a currency to be popular (requirement 2), it seems that it cannot be stable in value (requirement 3). In other words, what makes Bitcoin (and Ethereum) popular (which is their apparent ever-increasing value) is the same market force that does not allow them to meet requirement number 3.

It's easy enough to build a stablecoin, but how can we put that stablecoin in the hands of users? This is not a trivial problem. A new stablecoin called Saga, introduced last March, will be sold as Saga tokens to the public. Why would one buy Saga? The motivation would be to get something that is a good medium of exchange. If I don't have ethers, I would have to use USD to buy Saga. What is the advantage of Saga over USD that I would want to exchange my USD for Saga? Can I use Saga to buy bananas at the grocery store? Not right away. The company behind Saga has to assure the grocer somehow that 1 Saga equals 1 USD, and there has to be a way for that grocer to easily accept Saga as payment.

If I have ethers, why would I exchange my ethers for Saga? Would Saga increase in value faster than ethers? No, in fact the whole point of Saga is that it does not increase in value.

Saga is a very good stablecoin backed by good capital and it has a few notable people behind it, but if its creators don't have a good way to distribute it, it is not likely to become popular.

There are two fundamental ways by which to initially distribute currencies in general:

1. By carrying money bills up in the air, in a helicopter, and spreading it around (“helicopter money” which means outright distribution). Outright distribution is very easy to do in cryptocurrencies, especially in the Ethereum blockchain. All that one has to do to distribute our token PUR, for example, is to write a smart contract for doing so. Let's say, we want to give away 5 PUR tokens for all accounts in Ethereum that has an ether balance (if it has an ether balance, then it is highly likely that somebody cares about such an account). All you need is a ten-line contract to do it—maybe even less. In fact, if you look into your Ethereum account, you will notice that you already own a few ERC20 tokens. If you distribute your stablecoins this way, though, its market value would automatically be zero (supply would far exceed demand). If it's worthless, then nobody would accept it as money. You can't buy bananas with it at the grocery.

2. Have a few people, who see value in your coin, exchange some of their fiat for your coin. In time, if this coin has valuable features like ease of transfer, security, and non-censorship, more people will use it, and demand will grow. As demand grows, either the quantity will have to be increased, or the quantity fixed and the price allowed to increase. The first option would make the coin a good medium of exchange, the second option would make the coin unusable as medium of exchange. The Bitcoin community chose the second option. The Ethereum design started off under the first option, but recently the Ethereum community has decided to fix the ether quantity.

The problem of popularity versus stability is not solved by any solution in the current state of the art.

### BRIEF SUMMARY OF THE INVENTION

According to at least some embodiments, the present invention provides a system and method for a stable cryptocurrency that uses its stability as an attractive feature for vendors, removing or at least reducing the risk on the accept-side. Optionally, the method supports payments through a plurality of cryptocurrencies, wherein the plurality of cryptocurrencies comprises a stablecoin and at least one other cryptocurrency that is not a stable cryptocurrency, the method operative through a system comprising: a user computational device, a user wallet interface operated by said user computational device, a server computational device, a server wallet interface operated by said server computational device, and a computational network in communication with said user computational device and server computational device; the method comprising: communicating a payment amount to said server, requesting said payment amount from said user wallet interface by said server wallet interface; wherein said payment amount is in at least two of said plurality of cryptocurrencies, including said stablecoin and said at least one other cryptocurrency; selecting a payment through said user computational device of either said stablecoin or said at least one other cryptocurrency; and effecting payment through said user wallet interface according to said selection. The vendor may then select whether to accept payment in the stablecoin, the at least one other cryptocurrency, or even a fiat currency.

The instant stable cryptocurrency may be described as a stablecoin, as distinguished from other cryptocurrencies that may be volatile. As described herein, other cryptocurrencies, including but not limited to Bitcoin (BTC), Ethereum, XRP, Bitcoin Cash (BCH), EOS and so forth are designated as volatile cryptocurrencies or as non-stable cryptocurrencies, in contrast to the stablecoin.

Preferably the system and method feature POS (point of sale) functionality, to support use of the cryptocurrency in transactions. The POS functionality may further support such transactions between suppliers, a buyer and a seller, and/or for exchange of the cryptocurrency with another cryptocurrency and/or a fiat currency. The POS functionality preferably accepts a plurality of cryptocurrencies, including the stablecoin and at least one other cryptocurrency.

While current state of the art focus on the spend-side, this invention shifts the focus completely on the accept-side. Without wishing to be limited by a single implementation, the system and method may guide the multi-faceted market in three phases:

Phase 1

Point-of-Sale (POS) functionality is implemented, for example by installing a POS app in vendors' mobile devices. This allows the vendors to accept a plurality of cryptocurrencies as payment: a popular cryptocurrency, which is not a stablecoin, and the stablecoin (which is termed herein a “stabletoken”). The POS functionality is preferably provided with reduced fees for cryptocurrencies. People who already hold the popular but volatile cryptocurrency are then encouraged to spend their cryptocurrency at these vendors because of very minimal transaction fees. In Phase 1, the stabletoken may not be used frequently for transactions.

Incidentally, current state of the art includes distribution of stablecoins programmatically (so-called “air drops”) in which a certain amount of a coin or token (say 100 stabletokens) are “dropped” into each account in a blockchain for free. Aside from being free, such method of distribution also does not require any effort on the part of the recipients. After an air drop, we can say that everybody already owns such a stablecoin, and there is no need to popularize it. The problem with this approach is that, because the public at large receives these tokens for free, it means that it has zero value, and it would remain “stable” at that value because no vendor would accept it as payment. In this invention, rather than distribute the stablecoin for free, the stablecoin is guaranteed to be equivalent in value to a fiat currency because every stabletoken will be backed by a unit of the fiat currency, whether fractional or multiples of such a unit. For example, 100 stabletokens could be backed by $1 USD.

In the case of users of this invention, vendors are willing to accept the volatile cryptocurrency as payment because they wouldn't be accepting the same volatile cryptocurrency: instead they would be accepting the stabletoken, a stablecoin. How can the stabletoken be made stable in Phase 1? By backing it with fiat currency. The company that manages the stabletoken (the user of this invention, in this case Pure Money Technology Inc) accepts the volatile cryptocurrency for every payment transaction. Such payment is then immediately sold at any of the pre-existing exchanges in exchange for fiat currency. In this way, every stabletoken is backed by its equivalent fiat currency (say USD). Vendors can exchange their stabletokens for equivalent USD anytime after normal trading and bank “settlement period”. This builds trust in the stabletoken among vendors who use the POS app.

Phase 1 summary: increase acceptors of the stabletoken by distributing the POS app among as many vendors as possible. Current owners or holders of volatile cryptocurrency are encouraged to go to these vendors to spend. Vendors are willing to accept volatile cryptocurrency as payment because they receive an equivalent amount of the stabletoken, which shields them from volatility of the popular but wildly varying cryptocurrency. The transactional exchange between the volatile cryptocurrency and the stabletoken is preferably performed in real time. Alternatively, the exchange may be performed later but with a value set in real time, to reduce the effects of volatility of the non-stabletoken cryptocurrency.

Phase 2

In Phase 2, wide distribution of the POS app now covers suppliers of Phase 1 vendors. This means that the Phase 1 vendors, rather than exchange all the stabletoken they hold to USD, can use some of their stabletoken to buy supplies. For example, let's say Phase 1 vendor A, a restaurant—instead of claiming the equivalent USD against all the stabletoken she holds—finds it more convenient to keep some of the stabletoken to buy next week's raw supplies from Phase 2 vendor B, a grocery. Because the POS app can also accept stabletoken, vendor B gladly accepts vendor A's payment in stabletoken. This may occur for example due to lower fees on the POS app for exchanges involving stabletoken.

Therefore, in Phase 2, part of the stabletoken distribution will remain in circulation and will not be converted to USD. This means that 1) the stabletoken company will increase its holdings of the backing fiat currency; and 2) it can be safe for the stabletoken company to not sell every volatile cryptocurrency it receives—it can keep some amount of volatile cryptocurrency unsold, especially if its price is going up. The stabletoken company starts profiting from trading in the open market, using a small portion of the backing it has now accumulated.

Phase 3

In Phase 3, the general population starts exchanging their USD for stabletokens because it has proven to be even more stable than USD and because a large part of their neighboring vendors now accept it. Some employers will start paying their employees in stabletoken, mainly because the employees themselves are asking for it. This increases the amount of stabletoken in circulation further, and also increases the assets of the company behind stabletoken. The company now becomes a “central bank” and it starts to apply some or all known techniques to keep the price of a basket of commodities stable with respect to the stabletoken by controlling the quantity of stabletokens in circulation: increasing its quantity in times of high demand, and decreasing it (by selling some of its assets in exchange for stabletokens) in times of low demand. The trust that users of stabletokens will have placed in the stablecoin will depend on how well the company behind the stabletoken manages it, keeping its value stable.

According to at least some embodiments, the system and method feature a user interface, which may optionally comprise an app or other downloadable software, a thin client such as a specialized browser or a browser plug-in, or another type of user interface. Optionally cryptocurrencies (also referred to herein as “coins”) may be accessed by customers according to information stored in a separate user wallet, which may be for example a private key and a user coin address. In some embodiments, this information is stored in a centralized coin management system.

Any suitable blockchain based currency which involves a distributed ledger, which preferably requires some type of cryptography, more preferably a public/private key encryption system, or hash or digital signatures, may optionally be used. Once a change—such as acceptance of a contract for a trade—is made and is written to the distributed ledger, this change is automatically securely, non-falsifiably, that is completely accurately, replicated to all network participants.

The nature of the distributed ledger is such that all parties to a transaction can see the details of the transaction and optionally further requirements for the transaction to be complete.

Such a distributed ledger would also have the advantage of fraud prevention with immutable, append-only Distributed Ledger Technology. For example, users attempting to fraudulently trade cryptocurrency units that they do not possess would be blocked.

According to at least some embodiments, there is provided a POS (point of sale) function, to support distribution and use of the stabletoken stablecoin. The POS app may comprise a read-only terminal to the cryptocurrency network; and may also feature a text-to-QR code converter. The minimum that the customer wallet needs in order to make a payment is just the vendor's (contract) address. This address can alternatively be scanned by the customer's wallet app with nothing but a piece of paper that the vendor can provide, with the QR code of the address printed on it. The minimum that the vendor needs to accept a payment is an address (an Ethereum account or address for example). Now it would be difficult for the customer to type that address into her wallet, so the next level of convenience is a printout of the address, which the wallet can scan—obviating the need to type a very long address. The POS app is preferably capable of showing, on the vendor mobile device's screen, not just the address, but also the amount to pay. It can also confirm the payment.

The POS app, through a connection to one or more blockchains like Ethereum and EOS, makes it possible to introduce a new stablecoin by being true to its purpose, as a medium of exchange. The proposed distribution method for the stablecoin has these desirable qualities:

1. It took Bitcoin nine years to be as popular as it is now, it took Ethereum only three years. The proposed distribution method will take only a year.

2. The proposed stablecoin will be stable from the very start, as its value will be pegged to the US dollar.

3. It does not require a large amount of capital to peg the stablecoin to the US dollar.

All three qualities are possible because of the inventive POS app:

1. Evangelists will make it possible to make the POS app ubiquitous, thereby making the stablecoin as popular as Bitcoin is now in a year or so. The POS app allows vendors to accept most any cryptocurrency (initially this may be ethers only—but most any cryptocurrency through Shapeshift.io and Evercoin.com for example). The POS app represents an enticing convenience for cryptocurrency holders to spend their holdings.

2. Initially, preferably every transaction that occurs through a POS app installation will be tied directly to a sell order in two or three possible exchanges (such as Coinbase for example). Preferably the platform will hold, in its exchange account, exactly the same USD amount as (or even slightly more than) the stablecoin amount released to vendors as payment.

3. Because the method preferably features selling all ethers received as payment from customers (vendors' customers), a low amount of capital is required to keep the stablecoin to fiat currency peg.

The POS app (preferably through its smart contract part) is preferably able to accept payments in either ethers, or another volatile cryptocurrency or a stablecoin as payment. This means that a vendor accepting the stablecoin doesn't have to exchange stablecoin for USD if its supplier also accepts the stablecoin. The supplier would rather accept stablecoin because

1. The transaction fees would be lower compared to accepting USD and optionally also lower than accepting the cryptocurrency;

2. Preferably the stablecoin can be transmitted more quickly into the supplier's account than the fiat currency and preferably also than the volatile cryptocurrency; and

3. The stablecoin may even be more stable than USD.

The third point needs to be explained a little further. Once the stablecoin becomes accepted as a currency, it can be disconnected from USD and measure its own value independent of USD. In other words, the value can be pegged to a specific Consumer Price Index (which can be designed to be more like the more accurate Laspeyres Index). The objective is to keep its value constant even in the face of a devaluing USD and other fiat currencies.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computing device”, a “computer”, or “mobile device”, it should be noted that optionally any device featuring a data processor and the ability to execute one or more instructions may be described as a computer, including but not limited to any type of personal computer (PC), a server, a distributed server, a virtual server, a cloud computing platform, a cellular telephone, an IP telephone, a smartphone, or a PDA (personal digital assistant). Any two or more of such devices in communication with each other may optionally comprise a “network” or a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIGS. 1A-1B show non-limiting, exemplary systems for a stable cryptocurrency according to least some embodiments of the present invention;

FIG. 2 shows a non-limiting example of a system for transferring cryptocurrency between a customer and a vendor;

FIG. 3 shows a non-limiting, exemplary method for payment through a POS app;

FIG. 4 relates to a non-limiting, exemplary method of executing an exchange between stabletoken and another cryptocurrency, in this example Ether, through smart contracts that execute through the Ethereum Virtual Machine (EVM);

FIG. 5 relates to a non-limiting, exemplary overall method for payment between a customer and a vendor;

FIGS. 6A-6B relate to non-limiting examples of a system with flows for transferring cryptocurrency and also optionally fiat currency between a customer and a vendor; and

FIG. 7 relates to a non-limiting exemplary method for installing a POS app at a vendor.

### DESCRIPTION OF AT LEAST SOME EMBODIMENTS

The present invention relates to a stable cryptocurrency, which is a monetary unit that is stored, traded and accessed on a blockchain. The present invention supports adoption of the stablecoin by supporting transactions in the stablecoin and at least one other cryptocurrency, for the user (buyer) and preferably also the vendor. As described herein, the system and method permit the user to select to make payment in the stablecoin or in another cryptocurrency that is not stable (that is, a volatile cryptocurrency). The vendor may also choose to receive payment in the stablecoin or in a volatile cryptocurrency, or optionally even in a fiat currency.

According to at least some embodiments the blockchain is optionally a public or permissionless blockchain, such as Bitcoin, EOS, Hashgraph or Ethereum, which is decentralized and which is a blockchain that anyone in the world can read, anyone in the world can send transactions to and expect to see them included if they are valid, and what the current state is. Preferably, the blockchain that is used is selected from the group consisting of EOS, Hashgraph and Ethereum, or a similar suitable blockchain. Optionally, the user pays a network fee in a cryptocurrency accepted by that blockchain as payment for the transaction. As a substitute for centralized or quasi-centralized trust, public or permissionless blockchains are secured by cryptoeconomics—the combination of economic incentives and cryptographic verification using mechanisms such as proof of work or proof of stake, following a general principle that the degree to which someone can have an influence in the consensus process is proportional to the quantity of economic resources that they can bring to bear.

One of ordinary skill in the art could easily select a distributed ledger and implement it within various embodiments of the present invention, for example according to information provided in “Blockchain Basics: Introduction To Business Ledgers” by Brakeville and Perepa, IBM, May 9, 2016.

A blockchain is a distributed database that maintains a list of data records, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. One well-known application of a blockchain is the public ledger of transactions for cryptocurrencies such as used in bitcoin. The data records recorded in the blockchain are enforced cryptographically and stored on the nodes of the blockchain.

“Settled” or confirmed or validated transactions become immutable because these records are put in blocks that are copied across all nodes (all nodes have the same copy of such confirmed blocks). This is what makes the blockchain immutable: it is practically impossible to modify any transaction that has been confirmed because such modification would have to be done across thousands of nodes around the world. By the same token, it is practically impossible to delete a blockchain, because all copies of it will have to be deleted.

A blockchain provides numerous advantages over traditional databases. A large number of nodes of a blockchain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the blockchain that creates a transaction can determine within a level of certainty whether the transaction can take place and become final by confirming that no conflicting transactions (i.e., the same currency unit has not already been spent) confirmed by the blockchain elsewhere.

The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain. For example, in the case of cryptocurrencies, a valid transaction is one that is digitally signed, spent from a valid digital wallet and, in some cases, that meets other criteria. In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

For all of these examples, security for the blockchain may optionally and preferably be provided through cryptography, such as public/private key, hash function or digital signature, as is known in the art.

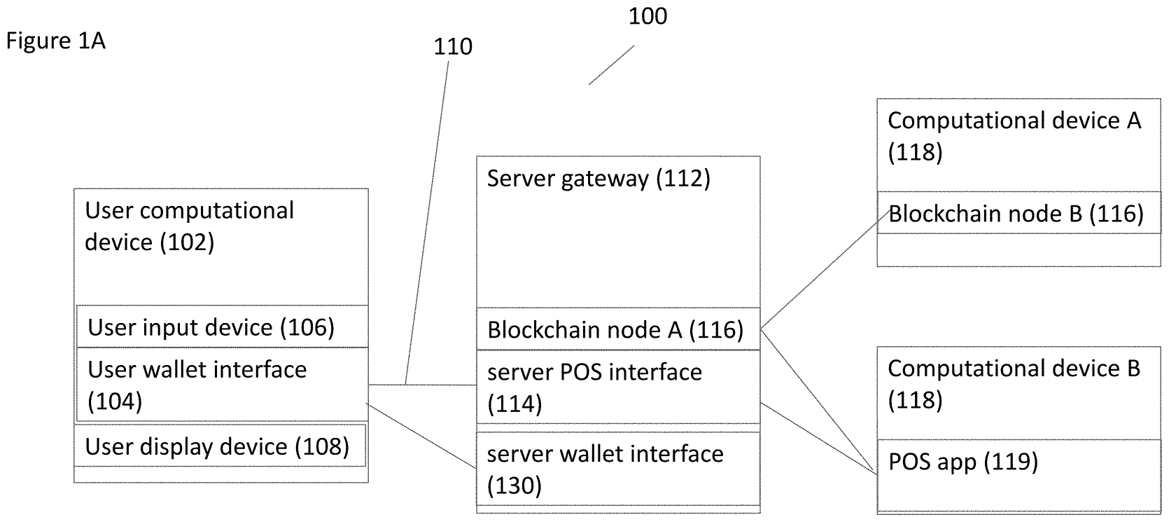

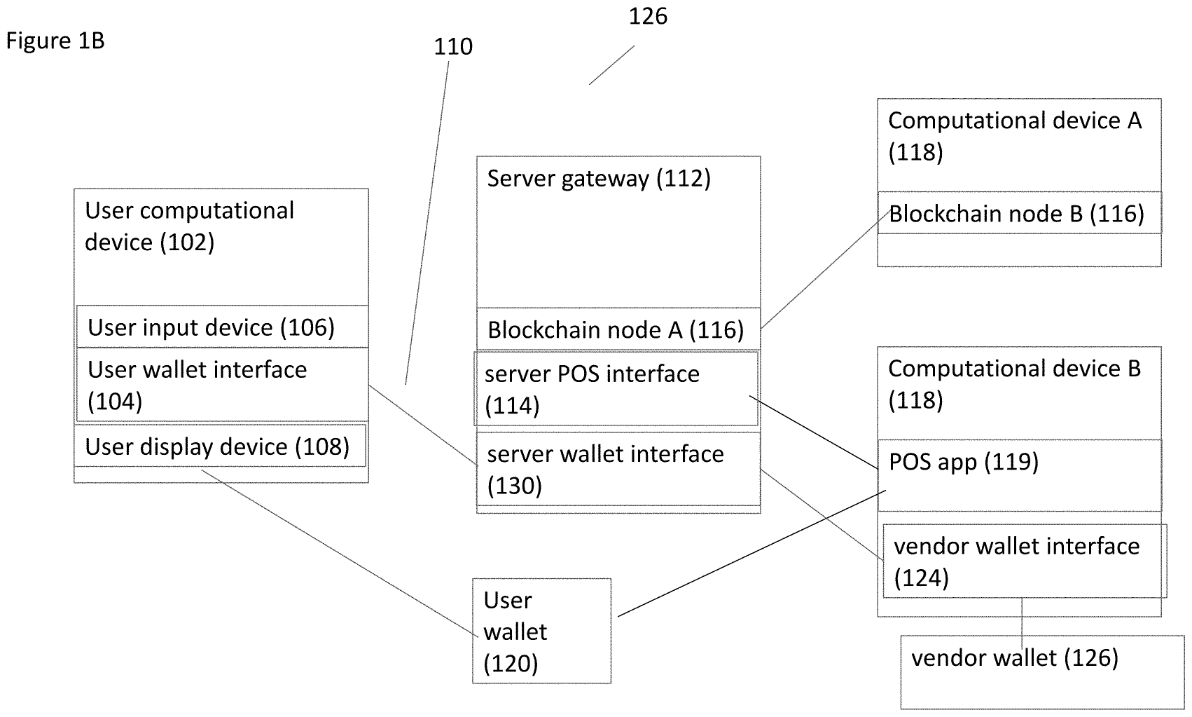

Turning now to the drawings, as shown in FIG. 1A, there is a system 100 featuring a user computational device 102, which communicates with a server gateway 112 through a computer network 110, such as the internet. User computational device 102 features a processor (not shown) for performing various instructions and commands. As used herein, a processor generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory (not shown). As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

User computational device 102 features a user input device 106, which may, for example, comprise a keyboard, mouse, other pointing device, touchscreen, and the like.

User computational device 102 may optionally comprise one or more of a desktop computer, laptop, PC, mobile device, cellular telephone, and the like. User computational device 102 also operates a user wallet interface 104 and a user display device 108. User display device 108 and user input device 106 may optionally be combined to a touchscreen, for example.

As used herein, a “user wallet interface” 104, or a user interface more generally, generally includes a plurality of interface devices and/or software that allow a customer to input commands and data to direct the processing device to execute instructions. For example, the user interface may include a graphical user interface (GUI) or an interface to input computer-executable instructions that direct the processor to carry out specific functions. The user interface employs certain input and output devices to input data received from a user or output data to a user. These input and output devices may include a display, mouse, keyboard, button, touchpad, touch screen, microphone, speaker, LED, light, joystick, switch, buzzer, bell, and/or other customer input/output device for communicating with one or more customers.

User wallet interface 104 preferably supports buying and/or selling and/or otherwise exchanging cryptocurrencies, with each other and/or with fiat currency. User wallet interface 104 preferably also supports purchasing goods and/or services with a cryptocurrency. Preferably a plurality of cryptocurrencies are supported, including at least the previously described stablecoin, stabletoken.

User wallet interface 104 communicates with a server wallet interface 114 on server gateway 112. This enables user computational device 102 to receive information about the cryptocurrency quantity, about trades, about the state of the users, cryptocurrency holdings, and other information with regard to the blockchain, which is shown generally as a blockchain having a plurality of nodes, each identified as blockchain node 116. This information is in turn derived from information regarding Accounts (or addresses) and Transactions between Accounts. Other data (including account balance or account token balance) may be derived or calculated from transactions. Throughout this description, all blockchain nodes are connected through blockchain, even if such connections are not explicitly shown.

Server gateway 112 preferably also comprises a processor and a memory (not shown), in which the processor executes instructions stored on the memory, for example to execute the functions of server wallet interface 114. The processor of server gateway 112 preferably comprises a hardware processor configured to perform a defined set of basic operations in response to receiving a corresponding basic instruction selected from a defined native instruction set of codes; and memory for storing the codes; wherein said computer instructions comprise a first set of machine codes selected from the native instruction set to support transactions between the stablecoin and a different cryptocurrency, a second set of machine codes selected from the native instruction set to determine an amount of the difference cryptocurrency and/or of the stablecoin to accept in payment, to support seamless exchange between the correct amounts of these currencies; and a third set of machine codes selected from the native instruction set to perform the exchange. Other such instructions as necessary may be provided in terms of machine code selected from the native instruction set, to support other functions of server gateway 112 and/or of user computational device 102.

Server gateway 112 operates a blockchain node A, which is a blockchain node 116. As shown with regard to FIG. 1A, a plurality of computational devices 118, one of which, computational device A, operates a blockchain node 116, shown as blockchain node B. Each such computational device featuring a blockchain node comprises a memory, which is not shown, for storing information regarding the blockchain. In this non-limiting example, blockchain nodes 116A, B belong to a single blockchain, which may be any type of blockchain, as described herein. However, optionally, server gateway 112 may operate with or otherwise be in communication with different blockchains operating according to different protocols.

FIG. 1A shows blockchain nodes 116A, B as communicating, but in fact, in operation of the blockchain, each such computational device retains a complete copy of the blockchain. Optionally, if a blockchain were to be divided, then each computational device could perhaps only retain a portion of the blockchain. With the preferred embodiment described herein, each computational device retains a complete copy of the blockchain. The communication lines are simply shown to indicate that all of the blockchain nodes retain a copy of the blockchain, preferably a complete copy of the blockchain rather than to show communication directly between the computational devices. Optionally, however, server gateway 112 does communicate directly with computational device 118A through computer network 110.

In addition, system 100 also preferably features another computational device 118, which is computational device B. Computational device B 118 operates a POS app 119, which is also preferably in contact with server POS interface 114.

In operation of system 100 of FIG. 1A, user computational device 102 may, for example, wish to pay for a product or service through user wallet interface 104, which may, for example, be a web browser plugin, a particular adapted type of web browser, a separate, standalone software, and the like. Upon receiving such a payment request, a server wallet interface 130 may then cause payment to be transferred according to writing to blockchain node A 116.

Optionally, server gateway 112 would then cause server wallet interface 130 to verify the existence of, place a hold on or otherwise obtain control of cryptocurrency to confirm that, in fact, the user operating user computational device 102 through user wallet interface 104 actually possessed or owned such cryptocurrency. The payment could then be executed through one or more smart contracts on blockchain node A 116, for example.

The execution of payment preferably relates to sending stabletoken, for example, to the vendor address on the blockchain. The amount is preferably equivalent to the USD value of payment. In other words, if the vendor is supposed to receive $23.45, then she will receive 23.45 stabletoken.

Preferably, stabletoken is transacted as for other cryptocurrencies, according to the RPC protocol between user wallet interface 104 and a node.

Payment could be made according to a request provided through computational device B 118, through POS app 119. POS app 119 would receive notification from server wallet interface 114 that payment had been made by writing to blockchain node A 116. Computational device B 118 would not therefore need to directly access a blockchain node 116 to be able to receive request for a payment to be performed.

POS app 119 allows a user (whether physically present or not) to purchase a product and/or a service as previously described. In such an implementation, preferably POS app 119 is able to accept a plurality of different types of cryptocurrencies, and server wallet interface 130 is able to read to, and write from, a plurality of different blockchains (not shown).

According to at least some embodiments, one or more cryptocurrencies could be favored for trading according to a trading fee, such that server wallet interface 130 and/or POS app 119 (through server POS interface 113) could cause differential amounts of fees to be charged for transactions involving different cryptocurrencies. Optionally bridging blockchains or other technologies are used to support multiple types of cryptocurrencies. Optionally the fee would be passed onto the purchasing user through user wallet interface 104. Alternatively, the fee would be charged to the seller through POS 119. The fee could also be split.

According to at least one embodiment, network fees may be included as a fixed amount, and/or assessed as a percentage amount, or a combination thereof. Optionally a fixed amount of network fees is combined with a fee of 1% of the payment amount. Preferably these fees are processed together, as part of the same payment transaction. Also preferably, to cover the network fees, an additional amount is taken from the payor's account, over and above the payment amount. For example, server wallet interface 130 could support deduction of this additional amount from the user wallet, by permission given by the user through the user wallet (not shown, see FIG. 1B) and in turn through communication with blockchain node A 116. Optionally server wallet interface 130 would receive permission from user wallet interface 104 to deduct both the base amount of the payment request, plus the network fees, through communication with blockchain node A 116.

Optionally these additional fees are displayed to the user through a display function of computational device B 118, according to information provided by POS app 119, for example in the form of a QR code.

Another option is to throttle the speed with which various transactions settle. For example, a payment involving one type of cryptocurrency may be performed at a more favorable rate than a payment involving a different type of cryptocurrency. Speed may be tied to the fee, with a higher speed having a higher or lower fee, or may be unrelated to a fee level that is charged.

The vendor associated with computational device B 118 may choose to receive payment in various ways, for example through a vendor wallet interface 124 operated through computational device B 118 and/or a vendor wallet 126 (not shown, see FIG. 1B). However the vendor could also choose to receive payment through other mechanisms (not shown). The account or address is associated with its private key that the vendor can safeguard. Therefore, to receive a payment, the vendor could for example post a QR code or show the QR code through computational device B 118. To pay, the customer scans that QR Code, for example through computational device A 118, such that the scanned QR code is functionally connected into his wallet, and then specifies the amount to pay. In this case, if POS app 119 is not available to receive payment, the vendor would need to be separately notified that payment was successful.

POS app 119 preferably simplifies the above process by providing a mechanism to accept payment and also the amount to be paid, including any network fees. For example POS app 119 is connected to the address or account to which payment is made, and also determines the amount to be paid. Optionally POS app 119 causes a QR code to be displayed to effect this payment. POS app 119 may also provide other features such as a menu of products or services being sold, for convenience of sales.

FIG. 1B shows a slightly different configuration of a system 100. This configuration of the system 100, the user computational device 102 is in communication with the user wallet 120. The user wallet 120 is a holding software operated by a computational device or a platform which would hold or possess the private keys to the cryptocurrencies owned by the user and would store them in a secure manner. Different blockchains may be operated for this purchase to occur. In this non-limiting example, user wallet 120 may optionally be located on user computational device 102 and/or may also be located in an off-site location and, for example, may be located in a server, a server farm, operated by or controlled by a centralized exchange (not shown).

Optionally user wallet 120 is a full node of the blockchain. Alternatively, user wallet 120 communicate with server gateway 112 to write to and read from the blockchain. In either case, whether indirectly or directly, user wallet 120 enables transactions to be performed through the blockchain, for example to spend cryptocurrency, exchange or purchase cryptocurrency and so forth.

Optionally computational device B 118 is in communication with a vendor wallet 126, which may again store private key(s) associated with the vendor for cryptocurrency transactions. Again, these key(s) may be stored at wallet manager 122 or at another location (not shown). Payments, or notification of such payments, may also be performed by communication through a vendor wallet interface 124 with server gateway 112.

For all methods as described herein, implementation is assumed to be through one or more computational devices, with appropriate software, operating on a computer network.

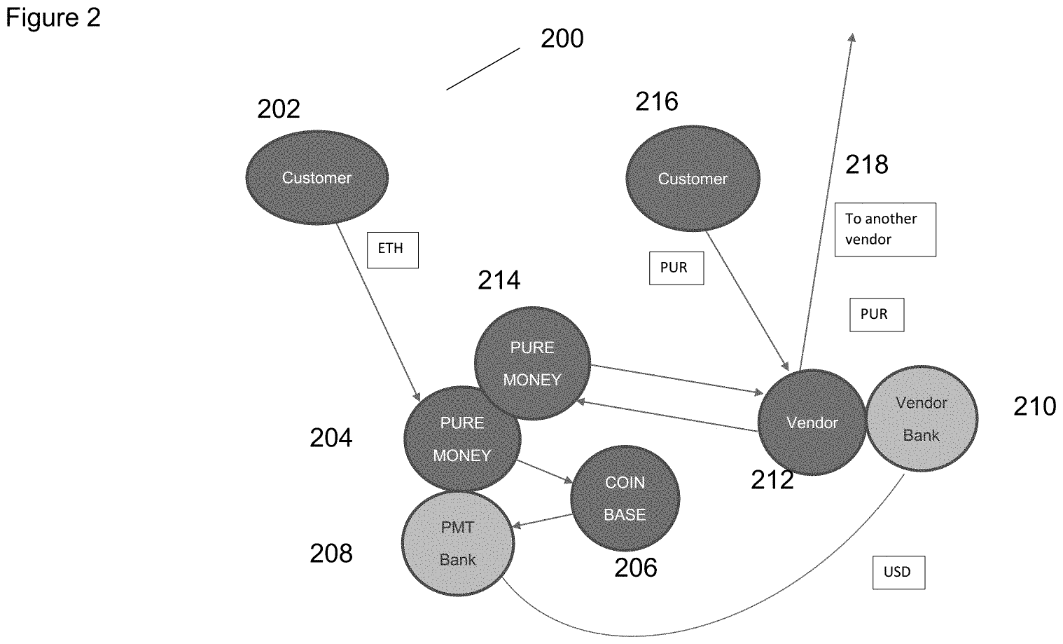

FIG. 2 shows a non-limiting example of a system for transferring cryptocurrency between a customer and a vendor, with the optional addition of making an exchange between cryptocurrency and fiat currency. Blue accounts are ETH accounts; Green accounts are stabletoken accounts; and Orange accounts are fiat bank accounts. As shown, the POS system does not directly transfer money from a cryptocurrency, such as the stabletoken account, to a fiat bank account. Rather, a cryptocurrency, such as ETH, is used to buy the fiat currency, which may then be sent to a fiat currency bank account as shown.

A system 200 uses a cryptocurrency called stabletoken money or stabletoken coins. Preferably the stabletoken money coins are directly linked to a store of value such as a fiat currency as shown in a bank 208 and/or to another cryptocurrency such as Ether. They may optionally be exchanged through an exchange 206. The flow is described in greater detail below.

As shown in the system 200, a customer 202 comes to a vendor which has the previously described POS (point of sale) capability, shown as vendor 212. Customer 202 pays in either ETH or optionally stabletoken money, indicated as the downward arrow from customer 202 to a stabletoken money source 204.

The POS app is supported with a device software or combination thereof, which supports payment in at least one, and optionally a plurality of cryptocurrencies, in which at least one cryptocurrency, such as stabletoken, is favored. By favored it is meant that at least one cryptocurrency has a lower transaction cost and/or a higher transaction speed. Optionally at least one cryptocurrency is not favored, at least initially. For example, if stabletoken has not achieved sufficiently wide distribution, then stabletoken may not be favored initially, until sufficiently wide adoption has been achieved. By “wide adoption” it is meant that more than half of the released stabletokens are circulating and are not being claimed for USD or another fiat currency. The roll-out of the stabletoken may be done in three phases as previously described.

The ETH that is paid is sent to an exchange 206, such as coinbase for example, to place an order to convert it to a fiat currency such as USD for example (see arrow from stabletoken money source 204 to exchange 206). Conversion to fiat currency is made at exchange 206, although optionally such an exchange could be made at a bank 208. The price at which ETH was sold determines exchange rate from ETH to stabletoken. An equivalent amount of stabletoken is then stored in the vendor's stabletoken account shown as stabletoken money account 214 transferring to vendor 212.

Optionally vendor 212 then exchanges the stabletoken coins for fiat currency, shown as the return arrow from vendor 212 to stabletoken money account 214. Fiat currency is then transferred to the fiat currency bank account of vendor 212, for example from bank 208 to bank 210.

In another non-limiting example, customer 216 then chooses to pay in stabletoken money. As noted above, this type of payment may be expected in phase 3 of the stablecoin distribution. Payment may also be made from vendor 212 in stabletoken, or another cryptocurrency, to another vendor 218, in stabletoken or ETH. As noted above, this type of payment may be expected in phases 2 and 3 of the stablecoin distribution.

Throughout the flow of money, preferably the stabletoken money is backed by fiat currency. Payment is preferably made through a point-of-sale (POS) contact, which may be made for example at vendor 212 or another vendor 218. In this non-limiting example, the favored cryptocurrency would be stabletoken money. Preferably the POS app does not directly handle currency or private keys related to cryptocurrency.

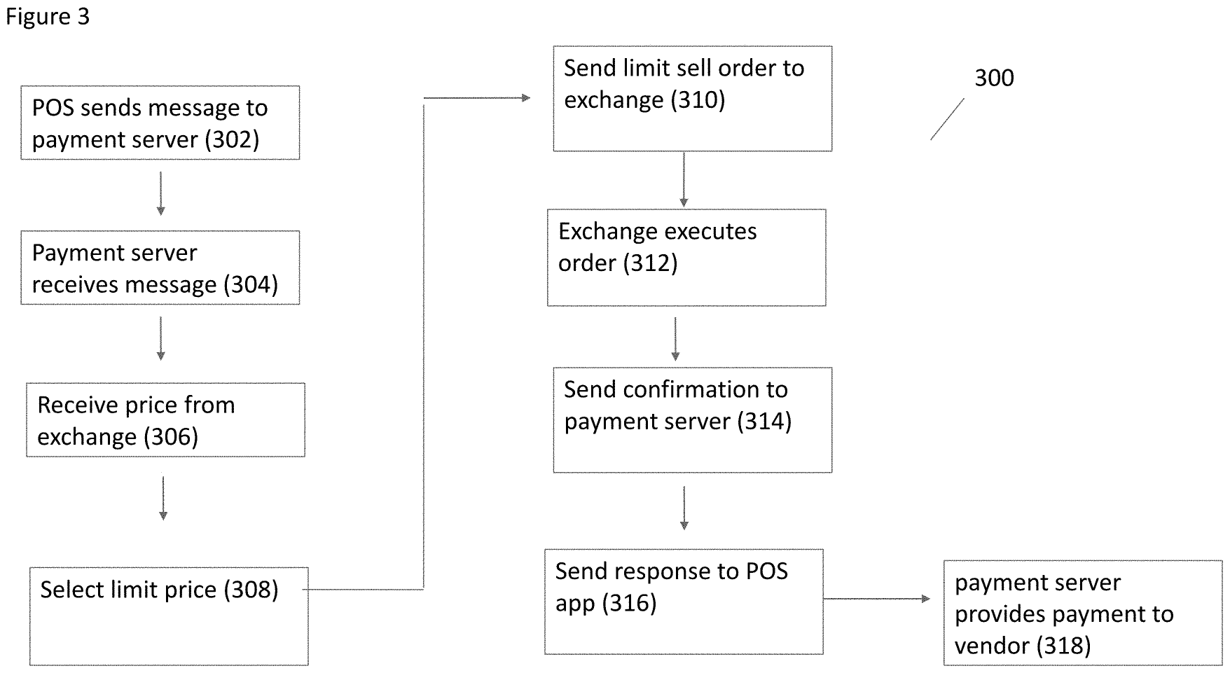

FIG. 3 shows a non-limiting, exemplary method for payment through a POS app. As shown in a flow 300, transactions occur between the previously described POS app, a payment server (such as the server of FIGS. 1A and 1B for example) and a cryptocurrency exchange, such as Coinbase for example. The transactions support payment of a product or service by a customer to a vendor, in this non-limiting example.

At 302, POS App sends message to the payment server, indicating a payment is about to occur. The message payload preferably includes a plurality of numbers, including the payment contract address and the equivalent amount in a fiat currency, such as US dollars for example. At 304, the payment server receives the message. At 306, the payment server receives price information from the exchange. Such information may be supplied on-demand or continuously.

At 308, the payment server selects a Limit Price based on the exchange rate information from the exchange. The exchange rate used by the POS App is preferably set as the same exchange rate or price at which ethers are sold. Prices can change rapidly, even every second, so our server receives an exchange rate ticker (a series of price data, exchange price, coming from every order that executes in the exchange—Coinbase in this non-limiting example). The payment server picks a price, and this price is used for the limit order. The same limit price is preferably sent back to the POS App immediately. Now when the POS App receives the three numbers from the API Server (Original USD amount, limit order price, and ETH (Ether) amount), it displays the ETH amount in the QR Code for the customer's wallet to scan. As soon as the customer taps the PAY button in her wallet, the payment is initiated from the customer's ETH account to the payment server's ETH account, which is the payment ETH account of the platform, also described herein as “Pure Money Tech”.

At 310, the limit sell order is sent to the exchange by the payment server, after the above process with the customer's wallet is performed. Alternatively, the limit sell order is performed before the above process with the customer's wallet, to be certain of receiving the most up to date prices. This change of order would result in selling ETH before receiving the customer's ETH, such that receiving the customer's ETH would replenish the supply of ETH available to the platform. The exchange executes the order at 312. Confirmation of execution of the order is sent at 314, from the exchange to the payment server.

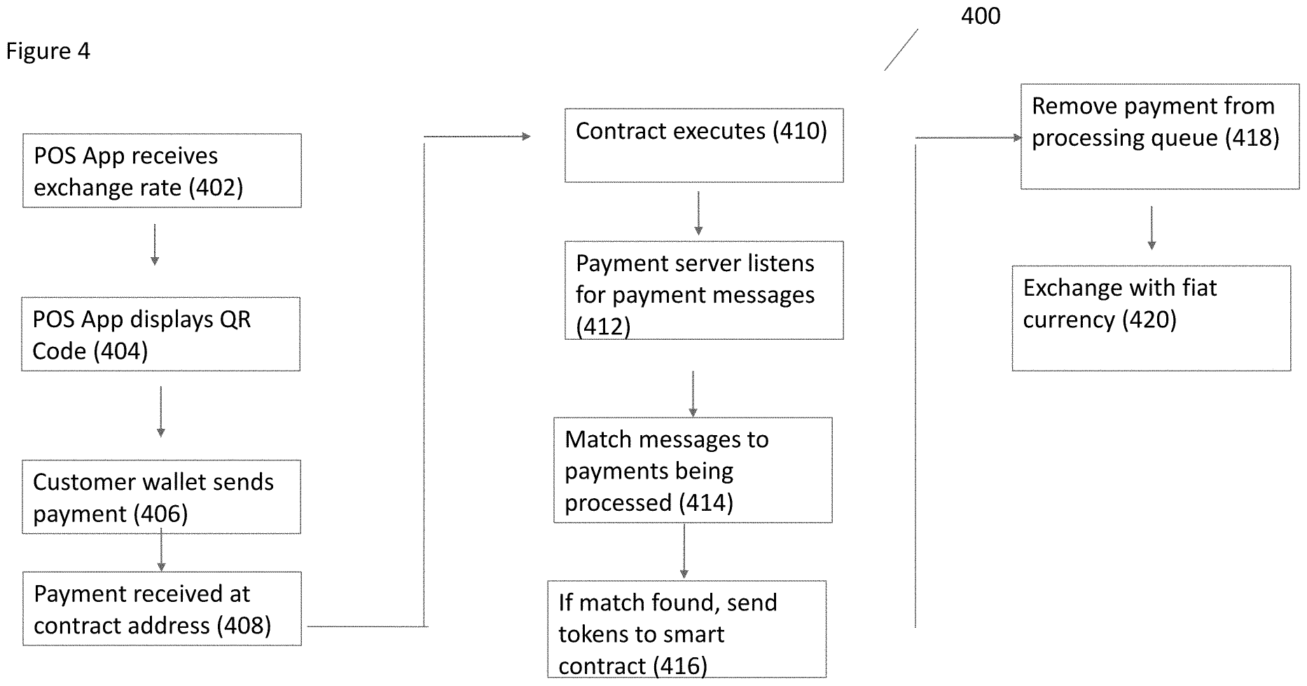

A response is then sent to the POS app, confirming execution of payment, at 316, from the payment server. The payment server then provides payment to the vendor in stabletoken as previously described, in 318. Optionally further steps occur between 316 and 318, as described for example in FIG. 4.

When the order executes, USD will be accumulated in the payment server account with the exchange (Coinbase). When the vendor claims this USD, the payment server receives the equivalent stabletoken back.

For the above examples, optionally payment is received by a vendor computational device, for example through a POS app or other similar software. The POS app may be operated by a different computational device (not shown) but preferably has similar functions to the functions described herein for the vendor computational device, in terms of receiving a request for effecting payment in a particular currency, optionally with a request by the vendor to receive payment in a different currency, along with any network fees described herein.

The vendor computational device preferably comprises a processor and a memory for storing instructions for execution by the processor, as described above. Preferably, the processor is configured to perform a defined set of basic operations in response to receiving a corresponding basic instruction selected from a defined native instruction set of codes. The codes are preferably stored in the memory. Preferably the computer instructions comprise a first set of machine codes selected from the native instruction set for identifying a currency being offered for payment to the vendor computational device, for example through the POS app, a second set of machine codes selected from the native instruction set for sending an identity of said currency and a vendor requested currency for payment to said server computational device; and a third set of machine codes selected from the native instruction set for receiving a total amount due in said currency, including a network fee.

Preferably, for this non-limiting example, the server computational device (which may also be termed a server gateway) comprises a server hardware processor configured to perform a defined set of basic operations in response to receiving a corresponding basic instruction selected from a defined native instruction set of codes. The codes may be stored in a server memory. Preferably the computer instructions comprise a first set of machine codes selected from the native instruction set to identify said currency being offered for payment, a second set of machine codes selected from the native instruction set to determine an exchange with said vendor requested currency; and a third set of machine codes selected from the native instruction set to determine said network fee according to said exchange, and to transmit said total amount due in said currency with said network fee to the vendor computational device.

FIG. 4 relates to a non-limiting, exemplary method of executing an exchange between stabletoken and another cryptocurrency, in this example Ether, through smart contracts that execute through the Ethereum Virtual Machine (EVM). In Ethereum, there are two kinds of accounts: 1) contract accounts and 2) human-owned accounts. Sending payment to a smart contract triggers the execution of contract code; sending payment to a human-owned account increases the balance of that account by the amount of payment. In both cases, transmission of payment to an address on the Ethereum blockchain represents a transaction.

As shown in a method 400, the process of exchange starts with 402, in which the POS App receives an exchange rate message from server as previously described. In 404, the POS App displays QR code for vendor contract address and payment required, in ETH, according to exchange rate received from server in 402.

Next, the customer wallet sends payment to a smart contract address for a vendor in 406. In this non-limiting example, the smart contract address is on the Ethereum blockchain and is associated with receiving payment in Ether. Preferably, every vendor has her own payment smart contract. Every vendor preferably also has her own account address (human-owned accounts). Customers pay the payment contract created specifically for one particular vendor.

The receipt of payment at the vendor's smart contract address at 408 then causes the smart contract to execute in 410. The smart contract may then distribute the stabletoken payment, according to pre-determined percentages, to the vendor (through the vendor's payment address and/or through a fiat currency bank account), the evangelist (described in greater detail below), Pure Money in the form of the smart contract associated with the payment server, and local government (optional).

Execution of the contract includes provision of a “payment received” message along with the amount, for example through a transaction to a smart contract address of the payment server. Alternatively, the payment server can monitor the smart contracts of associated vendors for any changes. In any case, the payment server listens for any indications of payments being made in 412.

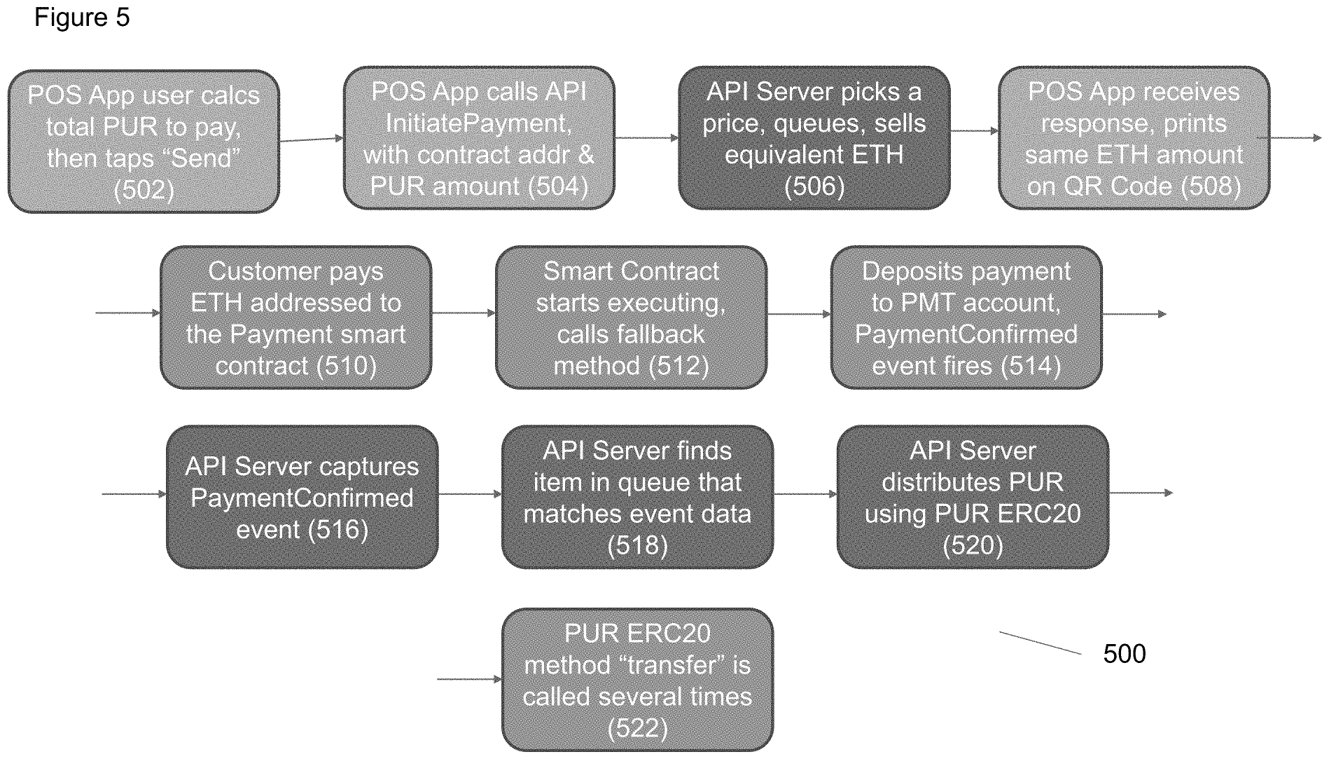

Messages related to payments being received are then matched to payments being processed, in a queue for processing, in 414. If a payment matches, then stabletoken is sent to the smart contract in 416. Optionally there are two smart contracts as described with regard to FIG. 5, the specific vendor “transaction fee” contract, and the non-specific ERC20 stabletoken contract. For the latter implementation, if a matching transaction is found, then the payment server executes the “transfer” method in the ERC20 stabletoken contract several times to distribute the stabletokens (see also FIG. 5 for more information). The payment is then removed from the processing queue by the payment server in 418. Optionally, payment is made to the vendor in fiat currency, which involves a transaction between stabletoken and the fiat currency, followed by transmission to the vendor's fiat currency bank account.

To support the above, the stabletoken Token may be implemented as an ERC20 token contract called PureMoney. This makes it tradeable in exchanges.

FIG. 5 relates to a non-limiting, exemplary overall method for payment between a customer and a vendor. For this non-limiting example, payment is assumed to occur through a PureMoney Smart Contract, with payment of a stabletoken ERC20 Token.

The below flow relates to a method of payment and interchange, in which stabletoken tokens are transferred from a main holding account (controlled by the payment server) to recipient accounts, which in this case include the vendor, optionally an evangelist (as described below), a network fee account, and optionally a government account, for example for paying taxes.

As previously described, every vendor has her own Payment smart contract (called TransactionFee contract in code). The vendor determines the USD amount to pay (to be paid in stabletoken) in 502, then sends a “payment request” to the payment server in 504. The API method InitiatePayment is called. Alternatively, as shown in 502, the amount of stabletoken may be sent as the payment request by the POS app, followed by sending the payment request.

The API Server executes InitiatePayment method in 506. The parameters to the method are the address of the Payment contract (specific to a vendor) and the stabletoken amount. The API server picks up a price from the ticker, and sends a sell order to the Exchange API in 506; it also puts the data in the proposed payments queue and responds to the POS App with the same data.

POS App receives data with ETH amount, displays it on screen as part of QR Code in 508. Customer wallet scans the QR Code and picks up the Payment contract address and amount to pay in ETH. Customer initiates payment. Wallet sends payment to vendor's Payment smart contract in 510.

Fallback method in Payment smart contract executes payment method in 512. ETH payment is deposited to the payment server custodial account in an exchange (Coinbase, for example), the event called “PaymentConfirmed” fires in 514.

API Server captures PaymentConfirmed event, picks up payor address, payee contract address, and ETH amount paid in 516.

API Server searches for transaction in queue corresponding to PaymentConfirmed event (need to match correct stabletoken amount) in 518.

The stabletoken amount is distributed among vendor (for example minus 1% transaction fee and sales tax—if enabled), evangelist (for example 0.7%), a network charge to handle payment costs (for example 0.3%), and local government, in 520.

The stabletoken ERC20 method called “transfer” is called several times, once for each of the accounts of distribution in 522.

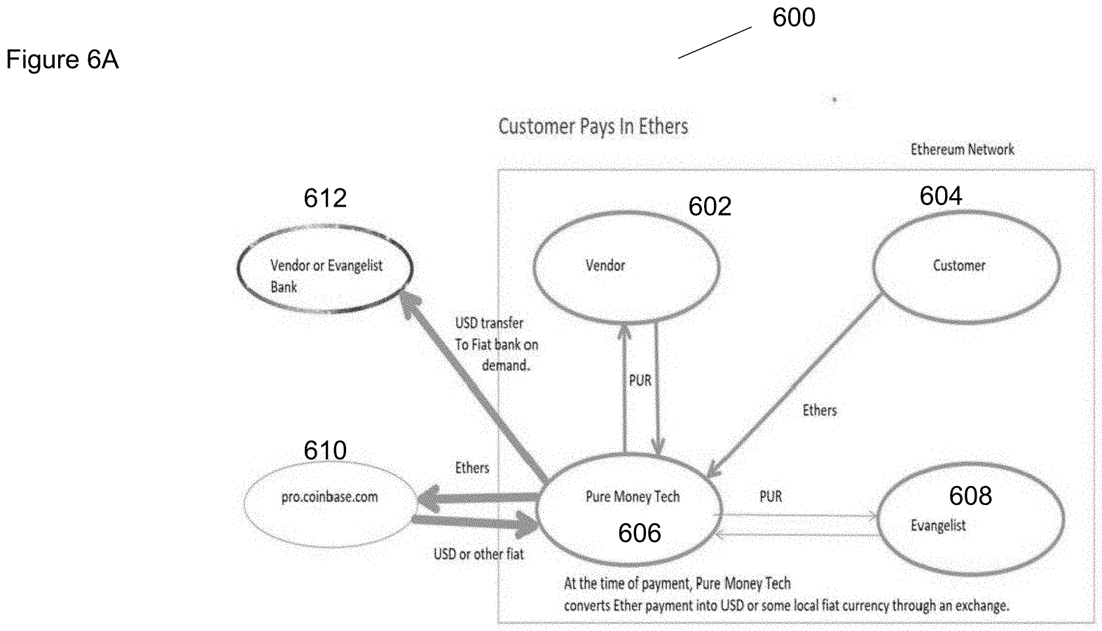

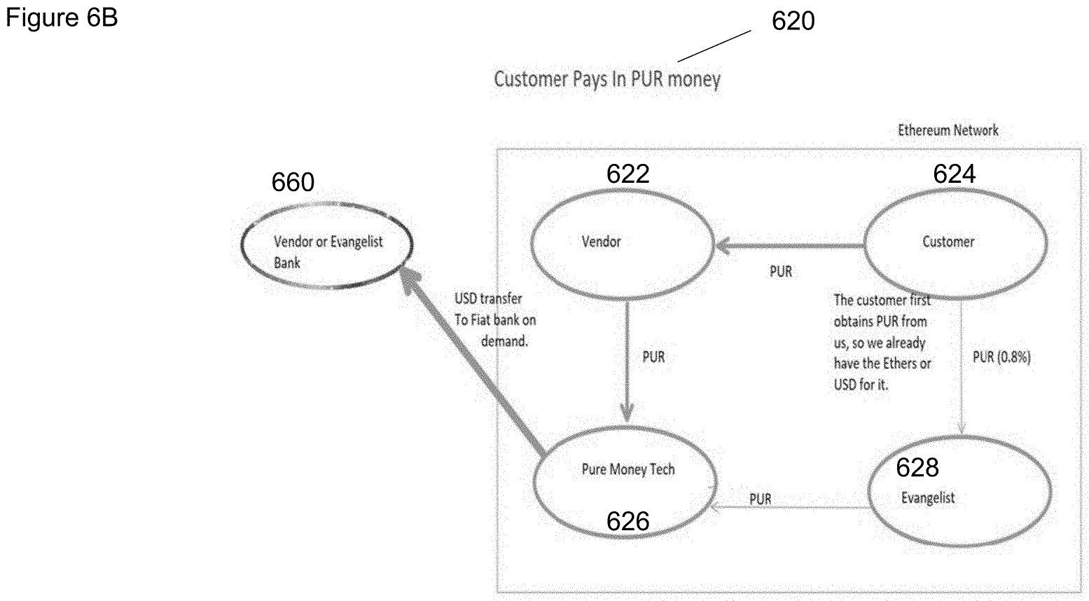

FIGS. 6A and 6B include payments that relate to an evangelist as well as to a vendor. FIG. 6A shows that payments are transferred in cryptocurrency between a customer and a vendor. Optionally, fiat currency is transferred by the payment platform from its fiat currency bank account to the vendor's bank account, if the vendor chooses to request the fiat USD in exchange for PUR days after the transaction). The fiat currency is obtained by selling the cryptocurrency, such as the ETH payment, received from the customer.

In FIG. 6A in the system 600, a customer 604 pays in ethers (ETH) and a vendor 602 receives stabletoken tokens. The ETH payment gets deposited by the payment smart contract to the account of the company that manages stabletoken (in this case Pure Money Technology Inc—606). At the same time, the same smart contract deposits an amount of stabletoken equal to ETH payment multiplied by instantaneous price of ETH in USD, to the vendor account 602. At least a day later, the vendor 602 can claim her USD from Pure Money Technology Inc 606 in return for stabletoken. The USD is sent by 606 to the vendor's account in bank 612.

Meanwhile, as soon as Pure Money Technology Inc (Pure Money Tech—606) receives the ETH payment, it is sent to an exchange 610 where it is sold automatically. The price for which it is sold is the same price by which the ETH payment amount is multiplied with, when converting to stabletoken.

FIG. 6B shows a system 620, in this case, where the customer chooses to pay in stabletoken money. In this example, the exchange is not involved, as payment is made in stabletoken and may then be exchanged for fiat currency for the vendor. The ability to accept payments in Stabletoken is important in the popularization of the Stabletoken. In this non-limiting example, fees to the platform are preferably reduced or even eliminated, while the evangelist 628 receives a fee, such as for example 0.8%. Optionally fiat currency is not used at all and the system retains payments in the stabletoken, including for the vendor, which may then use the stabletokens to pay suppliers and/or employees, for example.

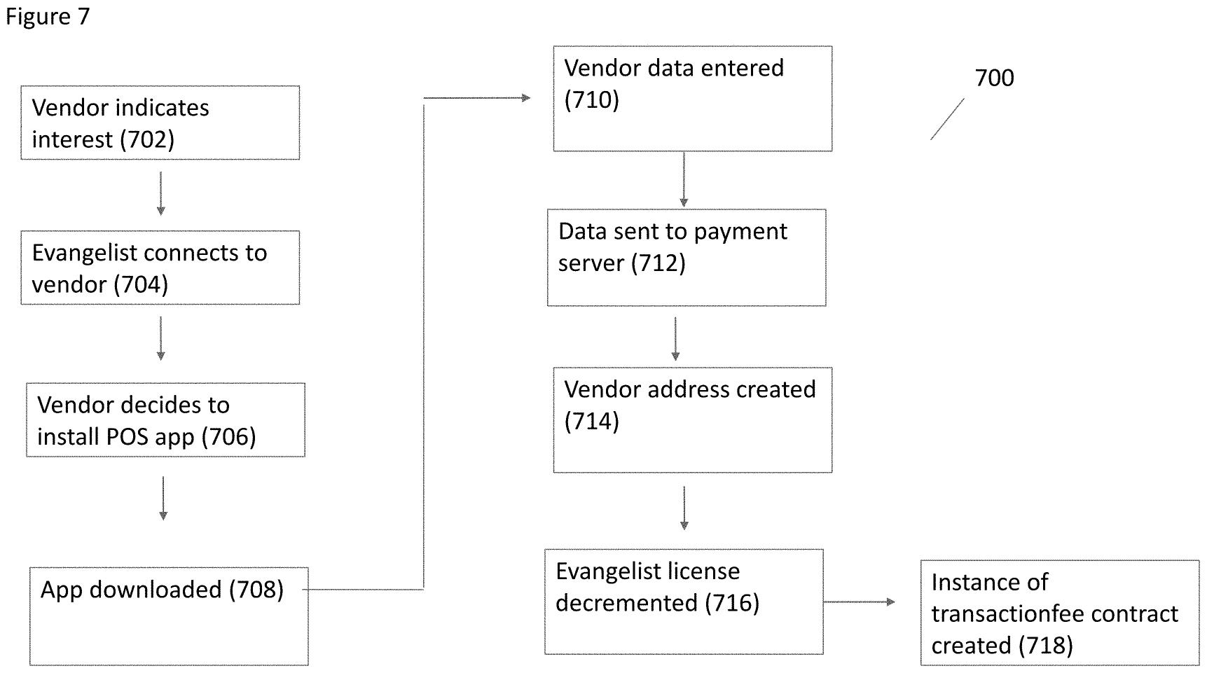

FIG. 7 relates to a non-limiting exemplary method for installing a POS app at a vendor with the help of an evangelist. The evangelist's physical address is preferably geolocated to a political boundary, which becomes her territory. Every vendor she recruits to install the POS App is also geolocated and checked whether the vendor belongs in the evangelist territory. There can be several evangelists in a territory, but they preferably do not approach the same vendor. The evangelist support portal will ensure that no two evangelists would deal with the same vendor.

As shown in a flow 700, a vendor indicates an interest in installing the POS app at 702, for example by registering at a portal associated with the payment server. The evangelist then connects to the vendor in 704, or alternatively the order of 702 and 704 is reversed. As noted above, the evangelist is preferably located in the same geopolitical territory as the vendor, so that the evangelist can act as a market maker and assist in the flow of stabletoken, optionally including with regard to fiat currency. The vendor then decides to install the POS app at 706.

After downloading and installing the app at 708, the vendor's data is entered at 710, for example including any business registration or tax numbers, and optionally a fiat currency bank account. This data is received by the payment server at 712. The vendor address(es) are then created on the blockchain at 714, for example including the payment and smart contract addresses. The evangelist license is then decremented at 716. Evangelists are preferably required to buy “License Tokens”, which may cost $1 to 5$ for example. If an evangelist buys 5 license tokens, these five tokens entitle him or her to install the POS App 5 times. An instance of the transaction fee contract is created at 718, to handle payment of network fees.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for supporting payments through a plurality of cryptocurrencies, wherein the plurality of cryptocurrencies comprises a stablecoin and at least one other cryptocurrency that is not a stable cryptocurrency, the method operative through a system comprising: a user computational device, a user wallet interface operated by said user computational device, a server computational device, a server wallet interface operated by said server computational device, and a computational network in communication with said user computational device and server computational device; the method comprising: communicating a payment amount to said server, requesting said payment amount from said user wallet interface by said server wallet interface; wherein said payment amount is in at least two of said plurality of cryptocurrencies, including said stablecoin and said at least one other cryptocurrency; selecting a payment through said user computational device of either said stablecoin or said at least one other cryptocurrency; and effecting payment through said user wallet interface according to said selection.

2. The method of claim 1, wherein said payment amount is in one or more of said plurality of cryptocurrencies and includes a network fee; wherein if said user wallet interface effects payment in said stablecoin, said fee is reduced by said server computational device than if said user wallet interface effects payment in a different cryptocurrency.

3. The method of claim 1, wherein said server computational device is in communication with a plurality of blockchains and wherein said server wallet interface requests payment through one of said plurality of blockchains.

4. The method of claim 1, herein said server computational device is in communication with a plurality of blockchains, wherein said server wallet interface requests payment by communicating with said user wallet interface, wherein payment is made through one of said plurality of blockchains and said server wallet interface listens to said blockchain to determine when payment is made.

5. The method of claim 1, further comprising a cryptocurrency exchange for exchanging cryptocurrencies for a fiat currency, wherein said server wallet interface is operative to receive payment in a cryptocurrency other than said stablecoin and to exchange said cryptocurrency amount received through said cryptocurrency exchange for a fiat currency.

6. The method of claim 5, further comprising a vendor computational device and a POS app operated by said vendor computational device, wherein said communicating said payment amount is performed by said POS app through communication between said vendor computational device and said server computational device.

7. The method of claim 6, wherein said vendor computational device comprises a vendor hardware processor configured to perform a defined set of basic operations in response to receiving a corresponding basic instruction selected from a defined native instruction set of codes; and a vendor memory for storing the codes; wherein said computer instructions comprise a first set of machine codes selected from the native instruction set for identifying a currency being offered for payment to said vendor computational device, a second set of machine codes selected from the native instruction set for sending an identity of said currency and a vendor requested currency for payment to said server computational device; and a third set of machine codes selected from the native instruction set for receiving a total amount due in said currency, including a network fee; and wherein said server computational device comprises a server hardware processor configured to perform a defined set of basic operations in response to receiving a corresponding basic instruction selected from a defined native instruction set of codes; and a server memory for storing the codes; wherein said computer instructions comprise a first set of machine codes selected from the native instruction set to identify said currency being offered for payment, a second set of machine codes selected from the native instruction set to determine an exchange with said vendor requested currency; and a third set of machine codes selected from the native instruction set to determine said network fee according to said exchange, and to transmit said total amount due in said currency with said network fee to said vendor computational device.

8. The method of claim 7, wherein said network fee is payable in said stablecoin or in a different cryptocurrency.

9. The method of claim 8, wherein if said currency being offered for payment matches said vendor requested currency, said network fee is reduced.

10. The method of claim 9, wherein if said currency being offered for payment is said stablecoin, said fee is reduced.

11. The method of claim 9, wherein said vendor requested currency is said stablecoin.

12. The method of claim 1, further comprising a vendor computational device and a POS app operated by said vendor computational device, wherein said communicating said payment amount is performed by said POS app through communication between said vendor computational device and said server computational device.

13. A method for supporting payments through a plurality of cryptocurrencies, wherein the plurality of cryptocurrencies comprises a stablecoin and at least one other cryptocurrency that is not a stable cryptocurrency, the method operative through a system comprising: a user computational device, a user wallet interface operated by said user computational device, a server computational device, a server wallet interface operated by said server computational device, a vendor computational device, a POS app operated by said vendor computational device, and a computational network in communication with said user computational device, said vendor computational device and server computational device; the method comprising: communicating a payment amount to said server by said POS app, requesting said payment amount from said user wallet interface by said server wallet interface; wherein said payment amount is in at least two of said plurality of cryptocurrencies, including said stablecoin and said at least one other cryptocurrency; selecting a payment through said user computational device of either said stablecoin or said at least one other cryptocurrency; and effecting payment through said user wallet interface according to said selection.

14. A system for supporting payments through a plurality of cryptocurrencies, wherein the plurality of cryptocurrencies comprises a stablecoin, the system comprising: a user computational device, a user wallet interface operated by said user computational device, a vendor computational device, a POS app operated by said vendor computational device, a server computational device, a server wallet interface and a server POS interface operated by said server computational device, and a computational network in communication with said user computational device, said user computational device and said vendor computational device; wherein said POS app is operative to indicate a payment amount and to communicate said payment amount to said server POS interface; wherein said server wallet interface is operative to receive said payment amount from said server POS interface and to request said payment amount from said user wallet interface; wherein said payment amount is in one or more of said plurality of cryptocurrencies and includes a network fee; wherein if said user wallet interface effects payment in said stablecoin, said fee is reduced than if said user wallet interface effects payment in a different cryptocurrency.

15. The system of claim 14, wherein said server computational device is in communication with a plurality of blockchains and wherein said server wallet interface requests payment through one of said plurality of blockchains.

16. The system of claim 14, wherein said server computational device is in communication with a plurality of blockchains, wherein said server wallet interface requests payment by communicating with said user wallet interface, wherein payment is made through one of said plurality of blockchains and said server wallet interface listens to said blockchain to determine when payment is made.

17. The system of claim 14, further comprising a cryptocurrency exchange for exchanging cryptocurrencies for a fiat currency, wherein said server wallet interface is operative to receive payment in a cryptocurrency other than said stablecoin and to exchange said cryptocurrency amount received through said cryptocurrency exchange for a fiat currency.

18. The system of claim 17, wherein said vendor receives payment in said fiat currency.

19. The system of claim 14, further comprising a vendor wallet operated by said vendor computational device, wherein said vendor wallet is operative to receive said payment amount in a cryptocurrency.

20. The system of claim 19, wherein said vendor wallet is operative to receive said payment amount in said stablecoin.

21. A system for supporting payments through a plurality of cryptocurrencies, wherein the plurality of cryptocurrencies comprises a stablecoin, the system comprising: a user computational device, a user wallet interface operated by said user computational device, a vendor computational device, a POS app operated by said vendor computational device, a server computational device, a server wallet interface and a server POS interface operated by said server computational device, and a computational network in communication with said user computational device, said user computational device and said vendor computational device; wherein said POS app is operative to indicate a payment amount and to communicate said payment amount to said server POS interface; wherein said server wallet interface is operative to receive said payment amount from said server POS interface and to request said payment amount from said user wallet interface; wherein said payment amount is in one or more of said plurality of cryptocurrencies; the system further comprising a cryptocurrency exchange for exchanging cryptocurrencies for a fiat currency, wherein said server wallet interface is operative to receive payment in a cryptocurrency other than said stablecoin and to exchange said cryptocurrency amount received through said cryptocurrency exchange for a fiat currency.

22. The system of claim 21, further comprising a vendor wallet operated by said vendor computational device, wherein said vendor wallet is operative to receive said payment amount in said stablecoin; wherein said vendor wallet is operative to receive instructions to convert said stablecoin to a fiat currency through said server wallet interface.

23. A method for supporting payments through a plurality of cryptocurrencies, wherein the plurality of cryptocurrencies comprises a stablecoin, the method being operative with the system of claim 14, the method comprising: effecting payment in a cryptocurrency from said user wallet interface to said server wallet interface; wherein if said payment is received in said stablecoin, said vendor wallet is operative to receive said payment amount in said stablecoin; wherein said vendor wallet is operative to receive instructions to convert said stablecoin to a fiat currency through said server wallet interface.
